(19) United States
(12) Patent Application Publication
(10) Pub. No.: US 2021/0402597 A1
(43) Pub. Date: Dec. 30, 2021

(54) Systems, Methods, and Computer-Readable Media for Task-Oriented Motion Mapping on Machines, Robots, Agents and Virtual Embodiments Thereof Using Body Role Division

(71) Applicant: Microsoft Technology Licensing, LLC, Redmond, WA (US)

(72) Inventors: Kazuhiro SASABUCHI, Tokyo (JP); Naoki WAKE, Tokyo (JP); Katsushi IKEUCHI, Kirkland, WA (US)

(73) Assignee: Microsoft Technology Licensing, LLC, Redmond, WA (US)

(21) Appl. No.: 16/914,847

(22) Filed: Jun. 29, 2020

(51) Int. Cl. B25J 9/16; G06N 3/12

(52) U.S. Cl. CPC B25J 9/1656; B25J 15/00; B25J 9/1664; G06N 3/126

(57) ABSTRACT

Systems, methods, and computer-readable media are disclosed for task-oriented motion mapping on an agent using body role division. One method includes: receiving task demonstration information of a particular task; receiving a set of instructions for the particular task; receiving a configuration of an agent to perform the particular task, the configuration of the agent including a plurality of joints, and each joint belong to one or more of a configurational group, a positional group, and a orientational group: mapping the configurational group of the agent based on the task demonstration information; changing values in the orientational group based on one or more of the task demonstration information and the set of instructions; changing values in the positional group based on the set of instructions; and producing a task-oriented motion mapping based on the mapped configuration group, changed values in the orientation group, and changed values in the positional group.

### TECHNICAL FIELD

Embodiments of the present disclosure relate generally to mapping motions to robots, machines, agents, virtual robots, virtual machines, and/or virtual agents. More specifically, embodiments of the present disclosure relate to mapping task-oriented motions to robots, machines, agents, virtual robots, virtual machines, and/or virtual agents using body role division.

### INTRODUCTION

To train machines, robots, agents, and/or virtual embodiments thereof a task and/or movement may be taught in various ways. One way may include demonstrating low-level concrete knowledge by showing an exact motion required for a task. For example, a motion may be demonstrated in a particular context environment, and a digitalized representation of the motion may be produced. Another way may be to instruct high-level abstract knowledge by providing geometric constraints and/or explaining a task sequence instead of demonstrating an exact movement.

However, demonstrating low-level concrete knowledge by showing an exact motion required for a task may not scale to machines, robots, agents, and/or virtual embodiments thereof that have different body and/or joint configurations. Additionally, instructing high-level abstract knowledge by providing geometric constraints and/or explaining a task sequence may lack information on a preferred motion within the task context/environment. Such information may include a positioning of a base of a machine, robot, agent, and/or virtual embodiment thereof, and/or a configuration appropriate for a continuing task in the task sequence. Moreover, instructing high-level abstract knowledge may require a sophisticated motion planner to complete a complex task sequence, such as, for example, to reach a door handle position of a cabinet that enables achieving both opening the cabinet, and then reach inside the cabinet with another arm.

In order to integrate both levels of knowledge, body role division may be used to map both high-level instructions and one or more low-level demonstrations. The body role division may use information about the structure of a human body may be used to determine which body parts are dominant and may contain valuable hints for achieving the preferred motion within the task context/environment. The human body structure information may then be used to produce a reasonable/appropriate mapping of a human body structure to machines, robots, agents, and/or virtual embodiments thereof. Other body parts, which are not dominant, may be substitutional.

For example, a human trunk of a human body structure may act in a substitutional role for an arm, i.e. the human trunk may stabilize the whole human motion, or to act as a positional range extension depending on an elbow's bending degree. Human trunk movement itself may not influence an arm configuration, and thus, the arm movements are dominant (i.e., has control over the shape of the motion) and other human body parts (e.g., the human trunk) are substitutional. Such kind of structural analogy may be used to define a body's roles on a joint configuration of a machine, robot, agent, and/or virtual embodiment thereof.

As discussed in more detail below, using a method that maps both high-level task constraints and low-level motion knowledge using human body structure information is disclosed. The method may be used with human data and instructions, such as verbal instructions, obtained from a system used in the teaching of a machine, robot, agent, and/or virtual embodiment thereof, such as in a Learning from Observation paradigm. Additionally, the mapping method may scale to machines, robots, agents, and/or virtual embodiments thereof of various configuration, including machines, robots, agents, and/or virtual embodiments thereof which have less, equal, and more joints compared to a human. For example, arm links of a machine, robot, agent, and/or virtual embodiment thereof may be more than, equal to, or less than a structure of a human arm. Moreover, as discussed in more detail below, both high-level and low-level knowledge may prove essential for a complex task sequence, such as in a dual arm manipulation, and applying both high-level and low-level knowledge may be beneficial to machines, robots, agents, and/or virtual embodiments thereof that are not necessarily human structured.

### SUMMARY OF THE DISCLOSURE

According to certain embodiments, systems, methods, and computer-readable media are disclosed for task-oriented motion mapping on an agent using body role division.

According to certain embodiments, computer-implemented methods for task-oriented motion mapping on an agent using body role division are disclosed. One method includes: receiving, at a computing system, task demonstration information of a particular task; receiving, at the computing system, a set of instructions for the particular task; receiving, at the computing system, a configuration of an agent to perform the particular task, the configuration of the agent including a plurality of joints, and each joint belong to one or more of a configurational group, a positional group, and a orientational group; mapping, by the computing system, the configurational group of the agent based on the task demonstration information; changing, by the computing system, values in the orientational group based on one or more of the task demonstration information and the set of instructions; changing, by the computing system, values in the positional group based on the set of instructions; and producing, by the computing system, a task-oriented motion mapping for the agent based on the mapped configuration group, changed values in the orientation group, and changed values in the positional group.

According to certain embodiments, systems for task-oriented motion mapping on an agent using body role division are disclosed. One system including: at least one processor; and memory storing instructions for task-oriented motion mapping on an agent using body role division, the instructions, when executed by the at least one processor, include: receiving task demonstration information of a particular task; receiving a set of instructions for the particular task; receiving a configuration of an agent to perform the particular task, the configuration of the agent including a plurality of joints, and each joint belong to one or more of a configurational group, a positional group, and a orientational group; mapping the configurational group of the agent based on the task demonstration information; changing values in the orientational group based on one or more of the task demonstration information and the set of instructions; changing values in the positional group based on the set of instructions; and producing a task-oriented motion mapping for the agent based on the mapped configuration group, changed values in the orientation group, and changed values in the positional group.

According to certain embodiments, computer-readable storage media are disclosed that store instructions that, when executed by a computing system, cause the computing system to perform a method for task-oriented motion mapping on an agent using body role division. One method of the computer-readable storage media including: receiving task demonstration information of a particular task; receiving a set of instructions for the particular task; receiving a configuration of an agent to perform the particular task, the configuration of the agent including a plurality of joints, and each joint belong to one or more of a configurational group, a positional group, and a orientational group; mapping the configurational group of the agent based on the task demonstration information; changing values in the orientational group based on one or more of the task demonstration information and the set of instructions; changing values in the positional group based on the set of instructions; and producing a task-oriented motion mapping for the agent based on the mapped configuration group, changed values in the orientation group, and changed values in the positional group.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

In the course of the detailed description to follow, reference will be made to the attached drawings. The drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure.

Moreover, there are many embodiments of the present disclosure described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein.

FIG. 1 depicts a system that maps both high-level and low-level task knowledge in a complex task, according to embodiments of the present disclosure;

FIGS. 2A-2C depict three type of actions (end-effector actions) that cause a state transition with a rigid non-deformable object, according to embodiments of the present disclosure;

FIG. 3 depicts an eight-by-five direction space digitalization to express motions in a digitalized form, according to embodiments of the present disclosure;

FIGS. 4A-4C depict using body role division for various agents having various degrees of freedom, according to embodiments of the present disclosure;

FIG. 5 depicts an orientation goal, which use a palm direction representation from a human motion analogy, according to embodiments of the present disclosure,

FIG. 6 depicts positions to visit that are represented in a discrete form, according to embodiments of the present disclosure;

FIG. 7 depicts positions that are represented in a continuous form, according to embodiments of the present disclosure;

FIG. 8 depicts a method for task-oriented motion mapping on an agent using body role division, according to embodiments of the present disclosure;

FIG. 9 depicts a high-level illustration of an exemplary computing device that may be used in accordance with the systems, methods, and computer-readable media disclosed herein, according to embodiments of the present disclosure; and

FIG. 10 depicts a high-level illustration of an exemplary computing system that may be used in accordance with the systems, methods, and computer-readable media disclosed herein, according to embodiments of the present disclosure.

Again, there are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION OF THE EMBODIMENTS

One skilled in the art will recognize that various implementations and embodiments of the present disclosure may be practiced in accordance with the specification. All of these implementations and embodiments are intended to be included within the scope of the present disclosure.

As used herein, the terms “comprises,” “comprising,” “have,” “having.” “include,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” Additionally, the term “or” is intended to mean an inclusive “or” rather than an exclusive “or.” That is, unless specified otherwise, or clear from the context, the phrase “X employs A or B” is intended to mean any of the natural inclusive permutations. For example, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

For the sake of brevity, conventional techniques related to systems and servers used to conduct methods and other functional aspects of the systems and servers (and the individual operating components of the systems) may not be described in detail herein. Furthermore, the connecting lines shown in the various figures contained herein are intended to represent exemplary functional relationships and/or physical couplings between the various elements. It should be noted that many alternative and/or additional functional relationships or physical connections may be present in an embodiment of the subject matter.

Reference will now be made in detail to the exemplary embodiments of the disclosure, examples of which are illustrated in the accompanying drawings. Wherever possible, the same reference numbers will be used throughout the drawings to refer to the same or like parts.

The present disclosure generally relates to, among other things, mapping task-oriented motions on machines, robots, agents and/or virtual embodiments thereof having various configurations using body role division.

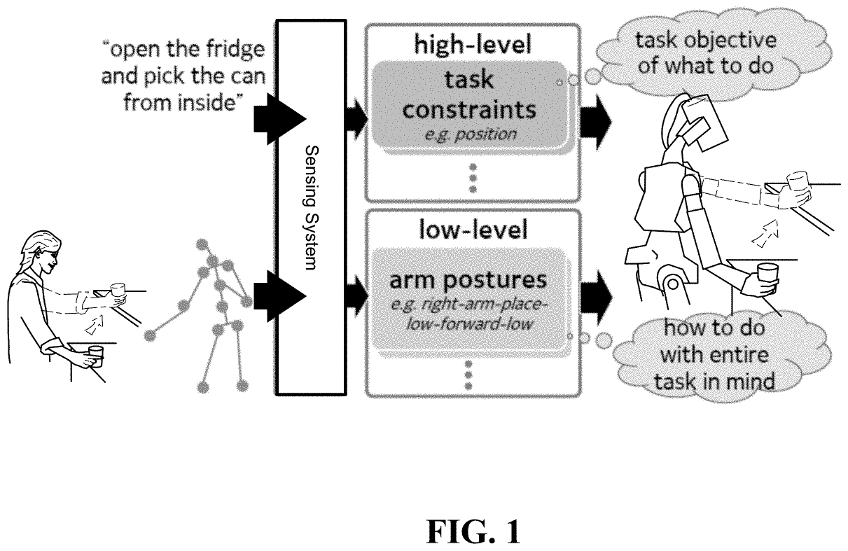

Referring now to the drawings, FIG. 1 depicts a system that maps both high-level and low-level task knowledge in a complex task, according to embodiments of the present disclosure. As shown in the upper portion of FIG. 1, a set of instructions (for example, verbal instructions) may be provided during teaching of an agent, such as a machine, robot, and/or virtual embodiment thereof, and then, the instructions may be decomposed into a set of task constraints derived from end-effector actions, such as a position constraint derived from an end-effector position action. The decomposition process may be done using a knowledge database (e.g., using some lookup table, where a verb “open” with a target attribute “door” may be tied to a task model defining required parameters for generating a list of position goals on a circular trajectory). As shown in the lower portion of FIG. 1, a motion demonstration may be performed/captured and a digitalized representation of the motion may be produced.

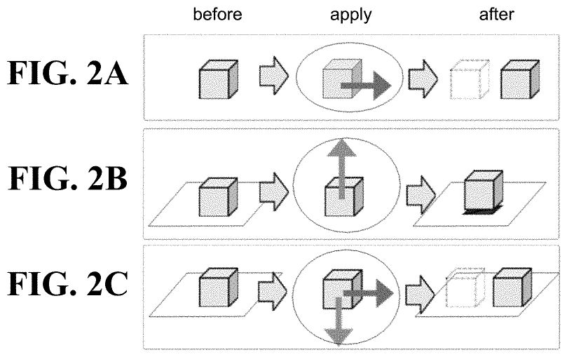

In a manipulation task, a state transition in an environment occurs as a result of a performed action by an agent, such as a machine, robot, and/or virtual embodiment thereof, e.g., a state of a cup in contact with a table to a state of a cup away from the table, i.e., no longer in contact with the table. FIGS. 2A-2C depict three type of actions (end-effector actions) that cause a state transition with a rigid non-deformable object, according to embodiments of the present disclosure. First, an action changing an end-effector of an agent, such as a machine, robot, and/or virtual embodiments thereof, position by p. Second, an action changing a force produced by the end-effector by f. Third, a hybrid action of the first and second task manipulation goals, i.e., task constraints derived from end-effector actions.

An end-effector position action p may define a change in a motion free direction, whereas, an end-effector action f may define a change in a non-motion free direction (i.e., a direction in which an end-effector is in contact with a rigid surface). Thus, the position and force actions may have a relation p−f=0, and many tasks on a rigid object may be described using the (p, f) action representation, such as, for example, pick-and-place, door opening, pressing a button, operating a kitchen faucet, etc.

FIGS. 2A-2C depict three type of actions. FIG. 2A depicts carrying an object in which [(p₀, f₀=0)], where p₀ may be a direction and an amount to move from a start position to a final position. FIG. 2B depicts lifting an object from a table in which [(p₀=0, f₀)], where f₀ may be in a table's normal direction to counter an attaching force (such as, for example, gravity, magnetism, etc.) on an object. FIG. 2C depicts wiping a table in which [(p₀, f₀), (p₁, A₁)], where p0, p1 may move on a table, and f₀ may increase a force to wipe the table and f₁ may decrease the force to stop the wiping.

Of the two actions, a force action may be defined during or after an agent, such as a machine, robot, and/or virtual embodiments thereof, achieves some configuration from a position action. At this state, the force action may act on a direction in contact with a rigid surface and may be constrained, and a configurational change produced by the force action may be very slight. As a result, a motion configuration may be kept while performing the force action.

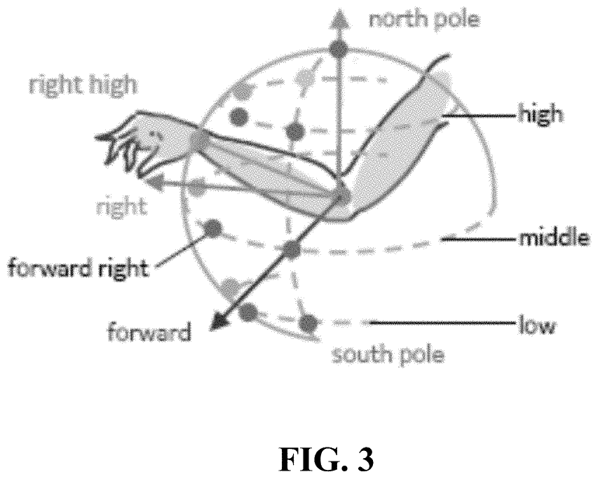

For a low-level demonstration, a sequence of human body postures may be provided during teaching. Then, each posture of the sequence of postures may be mapped to a defined joint configuration of an agent, such as a machine, robot, and/or virtual embodiments thereof, as shown in the bottom portion of FIG. 1. The low-level demonstration may provide configurational hints, which may simplify motion planning. Otherwise, a very high-level understanding of a relation between each task in a task sequence may be required. A number of postures to map may be finite by using a form of digitalization. That is, from an obtained three-dimensional (3D) skeleton of a human body, a direction of each bone may be calculated, and then, a direction space into a number of segments may be divided, as shown in FIG. 3.

FIG. 3 depicts an eight-by-five direction space digitalization to express motions in a digitalized form, according to embodiments of the present disclosure. In particular, FIG. 3 shows an example of a right forearm pointing in a right high direction, in which forward may be defined by a body facing direction at the beginning of a task. For example, a bone direction may be divided into eight horizontal directions (i.e., forward, left forward, left, left backward, backward, backward right, right, forward right) and five vertical directions (south pole, low, middle, high, north pole). The eight-by-five direction space digitalization may represent each arm bone to express a motion in a digitalized form. While FIG. 3 depicts an eight-by-five direction space digitalization, embodiments of the present disclosure are not limited to an eight-by-five direction space digitalization, and other direction space digitizations may be used.

By defining a finite number of mapped configurations a priori, digitalized data may be able to filter noisy jumps in a human motion or an obvious detection errors. For example, an unnatural arm twisted postures may be checked a priori in a digitalized form and then defined as unacceptable, whereas, raw continuous motion may produce increased noise from error in human bone tracking.

In body role division, a single task goal constraint, such as a goal position to achieve in a Cartesian space task coordinate when applied an end-effector action p, and a single motion configuration goal, such as a posture, are started with. For example, a moment of grasping an object may be started with. The agent, such a machine, robot, and/or virtual embodiments thereof, to be mapped may have an arm and an end-effector attached to the end of the arm.

As discussed above, a human body may be decomposed into one or more body parts that are a dominant part of a motion, which provide guidance (hints) for simplifying motion planning, and one or more body parts that are substitutional. Similarly, an agent's joint configuration may be decomposed into a dominant group q^{c}, which may be referred to as a configurational group, and a substitutional group q^{p}, which may be referred to as a positional group. Accordingly, rather than mapping a whole human body to an agent's body configuration, the dominant parts of the motion, which provides guidance for simplifying motion planning, may only be mapped. Thus, q^{c} may be obtained by mapping, and the remaining joints, q^{p}, may be solved by a task goal. To integrate a mobile base movement, base movements as part of a whole body configuration may be considered by defining a virtual prismatic and/or revolute joint attached to the agent's base. These virtual prismatic and/or revolute joints may belong to q^{p} but may also belong to q^{c} if the agent's configuration differs from a human structure, as discussed in more detail below.

In one example embodiment of the present disclosure, a human arm may be part of a dominant movement, which include a wrist-to-hand part of a body. This wrist-to-hand part of a body may belong to the configurational group q^{c} because wrist motion provides guidance (hints) on whether to grasp an object from a side or a top of the object. For example, side grasping may be appropriate when placing the object on a shelf, whereas top grasping may be appropriate when placing the object inside a basket. Such wrist motion information may not be handled from an instruction “pick up the object” of high-level task knowledge, unless a motion planner takes into account properties of a placing location.

In some tasks, the wrist motion may relate to a type of orientation goal, e.g., a grasp orientation goal, may drastically change from human demonstration of low-level task knowledge to when the agent is performing the learned task. For example, a picking strategy of a rectangular box on a table may change depending on an orientation around a yaw axis (i.e., gravity direction) of the box. Thus, a final mapped configuration may take into consider a demonstration and the knowledge about the grasp target.

In one example embodiment of the present disclosure, a human arm including the wrist may be part of a dominant movement. The low-level human wrist movement may be independent from upper arm movements and lower arm movements, such that, the wrist may independently change its mapped configurations to adjust for the high-level object orientation while using the same upper arm configuration and lower arm configuration. Thus, q^{o} may be defined as a partial joint configuration of the configurational group q^{c} that has both high-level mapping properties and low-level mapping properties for solving an orientation goal, such as a grasp orientation. q^{o} may be referred to as an orientational group, which may include an agent's one or more wrist joints.

Using the decomposition of an agent body into three role groups, i.e., dominant/configurational group q^{c}, substitutional/positional group q^{p}, and orientational group q^{o}, a configuration goal (such as an arm posture goal), a task goal, and an orientation goal may be solved using the following calculation on each role group.

First, map a configuration goal to a mapped configuration q₀^{o}, which may define a set of joint values for the configurational group, and set a positional group to a default joint configuration q₀^{o}, such as, e.g., zero values. Second, by changing joint values in the orientational group, modify q₀^{c} to joint configuration q₁^{c}, which satisfies orientational goal Ω_{ogoal}. Third, find a final configuration q that satisfies a task goal Ω_{pgoal} by mainly changing joint values in the positional group under a configuration constraint Ω_{ccons}, and a group connection constraint Ω_{pcons}.

Searching of a configuration in the last two steps may be performed by applying the goals constraints as a fitness function in a genetic algorithm. Discussed below is the mapping of an agent, and followed by the formulation of each of the aforementioned goals and constraints.

In a non-limiting exemplary embodiment, mapping of a human arm to an arm of an agent is discussed below. In embodiments of the present disclosure, the configurational group for an arm of an agent with different number of links may be determined, and demonstrated dominant (arm) motions may be mapped. Mapping design of a human arm posture to a mapped configuration q₀^{c} may depend on a number of links (excluding the end-effector) that compose an arm of an agent. In order to map an agent based on an agent with different number of links, three patterns may be defined. The first pattern may be a case where there are an number of equal degrees of freedom (DoF). For example, where there may be exactly two links, which excludes the hand, for representing the arm, which is the same as the human demonstrator. The second pattern may be a case where there are less DoF. For example, where there may be only one link for representing the arm, which is less than the human demonstrator. The third pattern may be a case where there are more DoF. For example, where there may be greater than two links for representing the arm, which is more than the human demonstrator.

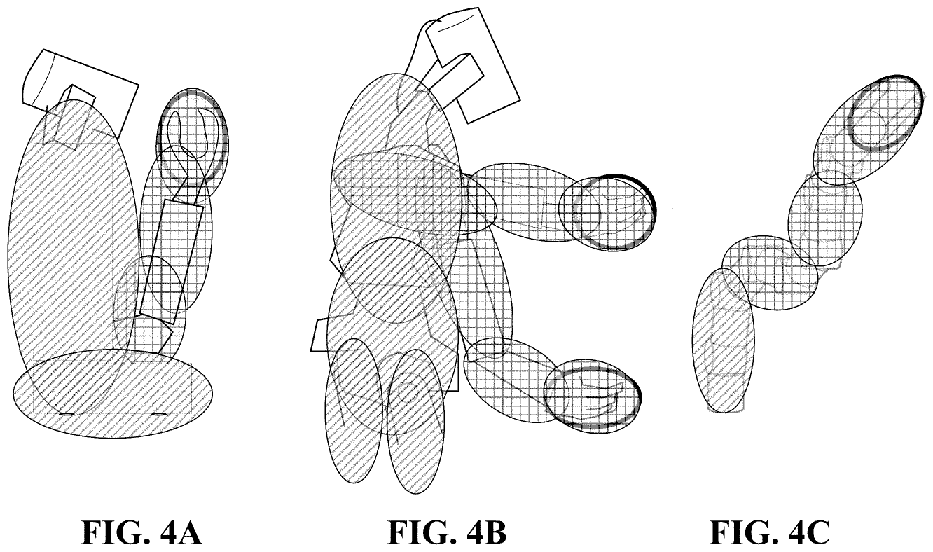

FIGS. 4A-4C depict using body role division for various agents having various degrees of freedom, according to embodiments of the present disclosure. In particular, FIG. 4A depicts an agent with less DoF than a human arm. FIG. 4B depicts an agent with equal DoF to a human arm, and FIG. 4C depicts an agent with more DoF than a human arm. As shown in FIGS. 4A-4C, the configurational group has a grid ellipse, positional group has a hash ellipse, and orientational group has a clear ellipse. While FIGS. 4A-4C depict a task where a dominant motion is an arm, embodiments of the present disclosure are not limit to dominant motions of a human arm and may be applied to other motions.

For the first pattern where there is an equal DoF, since there is only an equivalent number of links, the whole arm itself may be the configurational group. One approach to map an arm link (i.e., upper arm and lower arm) may be to do a frame-by-frame copy of a pointing direction for each corresponding arm link. However, this way of mapping may have no information on a joint-level interpolation between two mapped configurations, and thus, may lack human motion characteristics. For example, an arm may be reaching straight from a bent elbow position, the straight arm may be a singular point, and depending on the twist amount of the upper arm, different end-effector movements may be generated during the interpolation.

To achieve a smooth interpolating motion or a most likely collision avoiding motion, characteristics of the arm link may be considered. For example, an upper arm usually does not twist during a straight reaching motion, but an upper arm twist happens when moving the arm to different heights. Therefore, a mapped configuration may be created such that a pointing direction may be kept as much as possible, but the upper arm may not twist between reaching transitions and only twist when there may be transition in the height direction.

Using the digitalized form of arm motion representation, as explained above, the number of transition patterns may be finite. Thus, when an agent cannot precisely copy the pointing direction for one of the agent's arm links (e.g., due to joint limitations), the twist constraint may be prioritized when designing the mapped motion.

For the second pattern where there is less DoF, one approach to map arm motions to agents that have only one arm link may be to sum the pointing direction of the human upper arm and forearm into one direction. This approach may be suitable for gesture motions, and manipulation motions may have a slightly different characteristic. That is, collision between the forearm and the environment may be avoided by the positioning of the elbow and wrist, and thus, a summed pointing direction may miss such functionality.

To achieve a mapped configuration that may not be under collision, the forearm pointing direction may be mapped to the arm link, and a root of the arm link may be referred as the elbow. The upper arm may be assumed to be mainly used to adjust the forward/outward positioning of the elbow, and therefore, such functionality may be alternatively be managed with the positional group in most cases.

To achieve the forearm direction, the arm link may be actuated using a horizontally rotating joint and a vertically rotating joint. For some agents, a horizontal rotation may depend on rotation of the base, and therefore, in addition to the arm link, a virtual base rotation may also be included in the configurational group.

For the third pattern where there is more DoF, because there are more links than required for the mapping, the links may be chosen to be included in the configurational group. As in the second pattern with less DoF, to achieve a most likely not under-collision configuration, the mapped link may have the same length as the human arm. A multi-link arm may be composed of a number of short links. Therefore, a N closest links from the end-effector may be chosen, and M next-closest links may be chosen, such that the N, M links compose approximately the same length as the human forearm and upper arm respectively. If M is not long enough to compose an upper arm, the arm may be treated as the same as the second pattern where there is less DoF. Otherwise, the N+M links may be treated as the same as the first pattern where there is equal DoF.

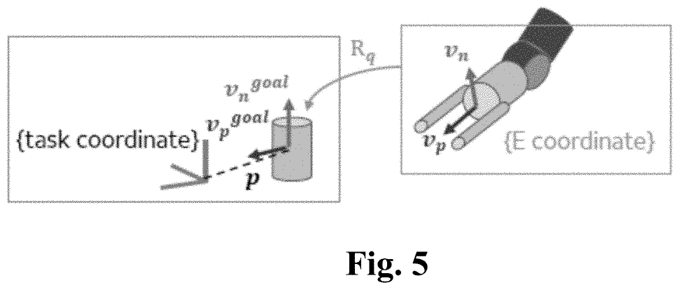

After mapping of a human posture to a joint configuration of an agent, an orientation goal may be solved. In order to represent an orientation goal in relation to human mimicking in an exemplary embodiment, a pointing direction of, for example, a palm may be used. FIG. 5 depicts an orientation goal, which use a palm direction representation from a human motion analogy, according to embodiments of the present disclosure. Using a palm analogy as a non-limiting example, a fixed palm unit vector vₚ may be defined on an agent's end-effector E represented in an E coordinate. A orientation goal may be to point this fixed palm vector toward a desired direction vₚ^{goal} in a fixed task coordinate. With this condition, the end-effector E may take any rotated pose around the palm vector. Therefore, one fixed perpendicular unit vector vₙ to represented in the E coordinate may be chosen, and vₙ may be pointed to a desired direction vₙ^{goal} in a fixed task coordinate. As shown in FIG. 5, an example of vₚ^{goal} may be a demonstrated direction, such as grasping a can drink from a side or top, and an example of vₙ^{goal} may be a constrained to a direction parallel to an axis of a cylindrical handle.

Thus, an orientational goal Ω_{ogoal} may be represented by two desired unit vectors vₚ^{goal} and vₙ^{goal} in a fixed task coordinate, where each vector may be obtained by either a demonstration (e.g., approach direction) or a task constraint (e.g., a defined axis of an object). vₚ, vₙ may be a fixed unit vector on an agent's end-effector E represented in an E coordinate, and R_{q} may be a coordinate transformation matrix that transforms vₚ, vₙ to the task coordinate when the agent's configuration is q. Then, using a predetermined threshold dₐ, d_{b} θₚ, θₙ the orientation goal may be written as follows.

$${Ω}_{ogoal} \text{(} \text{q} \text{):} \{ \begin{matrix}1 - {v}_{p}^{goal} \cdot {R}_{q} {v}_{p} < {θ}_{p} \\ 1 - {v}_{n}^{goal} \cdot {R}_{q} {v}_{n} < {θ}_{n}\end{matrix} \qquad ( 1 )$$

For task goal Ω_{pgoal}, p may be a desired position of the agent's end-effector E in a task coordinate, and h(qₛ) may be the agent's end-effector E position when the agent's configuration is qₛ, which may be calculated using forward kinematics. Then, using a predetermined threshold d, the task goal Ω_{pgoal} may be written as follows:

Ω_{pgoal}(qₛ): ∥h(qₛ)−p∥<d (2)

When solving task goal Ω_{pgoal}, a configuration constraint Ω_{ccons} and/or a group connection constraint Ω_{pcons} may be applied. The configuration constraint Ω_{ccons} may ensure that joint values of the configurational group is kept the near values of the mapped and modified joint configurations, as discussed above. The group connection constraint Ω_{pcons} may ensure that situations are avoided when links actuated by the positional group are the parent or child of the configurational group, and a change in value in the positional group may change the look of the links (pointing directions) actuated by the configurational group.

For configuration constraint Ω_{ccons}, configurational group qₛ^{c} in a sampled configuration is within a predetermined threshold dₑ from the configuration q₁^{c}, as discussed above where g₀^{c} is modified to joint configuration q₁^{c}, which satisfies orientational goal Ω_{ogoal}. qₛ^{c}ᵢ and q₁^{c}ᵢ may be an i-th joint value for each configuration, respectively. Configuration constraint Ω_{ccons} may be written as follows:

$${Ω}_{ccons} ( {q}_{s}^{c} \text{):} {\sum }_{i} \vert {{q}_{s}^{c}}_{i} - {{q}_{1}^{c}}_{i} \vert < {d}_{c} \qquad ( 3 )$$

As mentioned above, when links, e.g., pointing directions, are actuated by the positional group are a parent or a child of the configurational group, a change in value in the positional group may change a look of the links e.g., pointing directions, actuated by the configurational group. Group connection constraint Ω_{pcons} may avoid such a situation.

One way to represent the group connection constraint may be to use a similar strategy as Ω_{ccons}. L may be a subset of the positional group that influences a look of the links actuated by the configurational group, and the default joint configuration may be qₒ^{L}∈qₒ^{p} from the mapping of the configuration goal to the configurational group as the initial joint configuration q₀^{c} and the setting of the positional group to the default joint configuration q₀^{p}, as discussed above. The subset positional group qₛ^{L} in a sampled configuration may be kept close to qₒ^{L} within a predetermined threshold dₚ. Group connection constraint Ω_{pcons} may be written as follows:

$${Ω}_{pcons} ( {q}_{s}^{L} \text{):} {\sum }_{i} \vert {{q}_{s}^{L}}_{i} - {{q}_{0}^{L}}_{i} \vert < {d}_{p} \qquad ( 4 )$$

From the above, the body role division method on a single point data may be extend to a series of data obtained from a sensing system used in agent teaching, such as in a Learning from Observation paradigm. One type of data series may include where positions to visit are represented in a discrete form (e.g., points to visit in a picking task), and another type of data series may include where positions are represented in a continuous form (e.g., a trajectory in a door opening task).

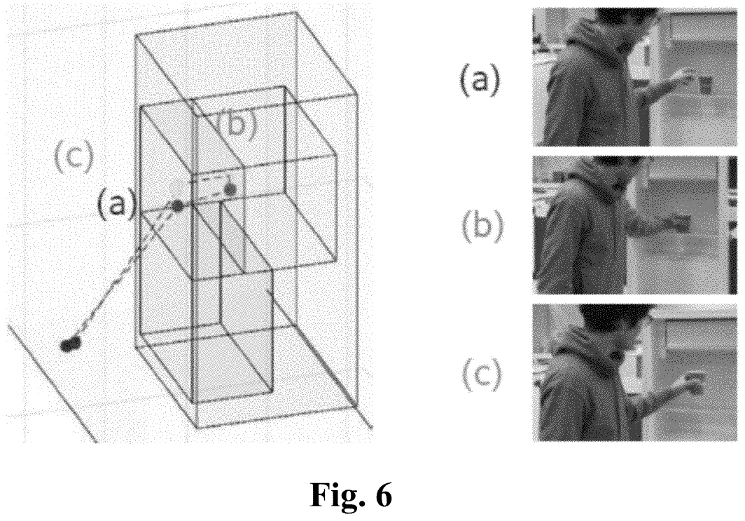

FIG. 6 depicts positions to visit that are represented in a discrete form, according to embodiments of the present disclosure. As shown in FIG. 6, visiting points, which are connected with a dotted line to express time relations, may be captured during a pick from fridge task using a learning from demonstration sensing system and a pre-defined spatial region map of an environment. In FIG. 6, (a) may represent visiting a point entering a fridge, (b) may represent a point before a grasp, and (c) may represent a point of exiting the fridge.

In certain tasks, such as a pick-and-place task, knowing locations that an agent's hand should visit may be more important than knowing an exact trajectory (i.e., Cartesian space values) a human hand went through. For example, important information for the task “pick-up a can from inside an opened fridge,” is that an agent's hand should visit a point entering the fridge, then pick-up a can, and then visit a point exiting the fridge. An agent may not have to be capable of following the exact demonstrated trajectory, as long as the point entering the fridge, the point before the grasp, and the point exiting the fridge are visited and collision is avoided. As in this example, some tasks represent position data in a discrete form. In this case, the Cartesian space position values of each discrete point may be provided as the task goal, and corresponding configurations may be found by matching a time stamp of human point-visiting data and human motion data, as shown in FIG. 5. The values for some visiting positions may slightly change between human demonstration and agent execution (e.g., the position of the can).

For these points, the task goal may be captured from recognition during execution. The required motion may change. Since motion representation may be in a digitalized form, any slight motion differences may be ignored as long as the positional change may also be slight. For example, in the case when picking an item in a fridge may be mostly located in the same place.

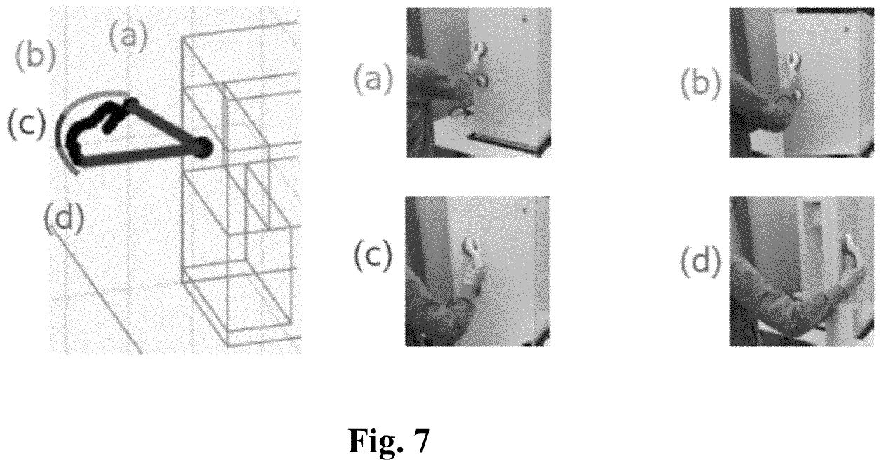

FIG. 7 depicts positions that are represented in a continuous form, according to embodiments of the present disclosure. As shown in FIG. 7, human motion and a fridge door opening trajectory may be captured by a sensing system used in agent teaching, such as in a Learning from Observation paradigm. In FIG. 7, regions (a), (b), (c), (d) on the left trajectory indicate where a digitalized human motion may not change, and the right images show a captured corresponding motion image.

In tasks where the positions are represented in a continuous form, an agent hand may follow positions on a specified trajectory. One exemplary task includes opening a door. In such a task, position data is continuous, and the task goals may be many points on the trajectory. As discussed above regarding discrete position goal representation, corresponding configurations may be found by looking up a time stamp. However, in continuous position goal representation cases, motion may rarely change with a digitalized motion representation, as shown in FIG. 7, jumps may be generated in a motion if applied directly as the configuration goal. To prevent such issues, an interpolated configuration may be mapped for each non-changing motion point by using two mapped configurations from a previous motion changing point q_{Au} and a next motion changing point q_{B}^{a}. In other words, an interpolated configuration (1−t)q_{A}^{a}+t q_{B}^{a} may be used as a configuration goal where t is an interpolation parameter.

The above-described method has been evaluated using a “pick-from-fridge” experiment to provide a use case scenario. The task included three instructed task, Task 1 (T1): “reach for a handle of a fridge” followed by Task 2 (T2): “open the fridge” and Task 3 (T3) “pick a can from inside the fridge.” In the experiment, the fridge will close if not held open, and the task must be conducted by opening and holding the fridge door with one arm, and picking the can with the other arm. A dual arm manipulation was required for T3. Additionally, geometric model parameters of the fridge and the can were assumed to be known.

An experimental agent was a robot with two 7 degrees of freedom arms, and an equal number of arm links as the human structure. The robot is able to localize itself in the task coordinate using a base laser scan. An inverse kinematics solver was used.

For the task goal of the body role division method, a continuous position representation, as described above, was used for T2 “open the fridge” and a discrete position representation, as described above, was used for T1 “reach for the handle of the fridge” and T3 “pick a can from inside the fridge,” All environment model parameters and model locations were known. The door opening trajectory was divided to waypoints per 0.1 radian. A value smaller than 0.1 radian results in base movements less than 3 centimeters, which is too small to be achieved with the configuration of the robot of the experiment.

For the motion configuration goal of the body role division method, arm motion data was obtained from a sensing system used in agent teaching, such as in a Learning from Observation paradigm, as described above. The arm motions were mapped to a predefined joint configuration using the method, as described above regarding a number of degrees of freedom of the robot.

The motion configuration goal were obtained from the sensing system as a single motion for T1 and T3; and using the interpolation parameter, as described above, for T2. For the orientation goal for T1 and T2, a direction within 45 degrees of the direction perpendicular to the door plane for vₚ^{goal}, and a direction parallel to the door handle axis for vₙ^{goal}. For T3, a demonstrated approach direction was used for vₚ^{goal}, and a direction parallel to an axis of the can axis was used for v_{z}^{goa}. The above-described method has been compared with three other methods, as described below.

A high-only comparison example solves only the task goal provided by high-level task instruction. The task goal and orientation goal was solved at once without any step-by-step calculation. When the high-only comparison example failed to find a valid real joint configuration (joints excluding virtual base joints) in the “open the fridge” task, a base movement was used to solve a positional displacement from a current configuration. An initial base position was calculated from the positional displacement between the desired handle position and a best found configuration that achieves the orientation when reaching the fridge door handle of T1.

A low-only comparison example solves only the motion configuration goal provided by the low-level motion demonstration. The low-only comparison example was a direct replay of the mapped configurations without any information about the task positions. An initial base position was positioned so that the position of the reached arm and the fridge door handle was matched at the beginning of the fridge door opening task in T2.

A no-role comparison example solves the task goal and the motion configuration is provided as an initial seed for solving inverse kinematics Other conditions were the same as the high-only comparison example. The no-role comparison example achieves a task goal and motion configuration, but without any information on which joints are dominant for maintaining the demonstrated motions, and which joints are substitutional to change from the demonstrated motion.

The body role division method uses the above-described body role division method. However, the agent (robot) used in the experiment cannot move its base and joints at once due to a power supply restriction. Accordingly, the positional group was used in the following manner: the task goal was solved using a waist under constraint Ω_{cons}. When a valid real joint configuration was not found, a base movement was used to solve the positional displacement from the current configuration.

In the four experimental methods, base movement was not used during the “pick a can from inside the fridge” task of T3. Applying a positional displacement of one arm (e.g., picking the can) would violate a constrained position of the other arm (e.g., holding the door handle). A task goal to keep the position of the other arm was added during the “pick a can from inside the fridge” task of T3, and the goal was solved by only using the robot's real joint configurations.

Table 1 depicts a comparison of the results obtain from the example methods in the pick-from-fridge task.

TABLE 1

| | High-only | Low-only | No-role | |
|---|---|---|---|---|
| | comparison | comparison | comparison | Body role |
| | example | example | example | division |
| | method | method | method | method |
| Solved without | 59% | — | 76% | 89% |
| base movement | | | | |
| Motion Jumps | Yes | No | Yes | No |
| Collisions | No | Yes | No | No |
| Task | Fail | Fail | Fail | Success |
| Achievement | | | | |

As shown in Table 1, the body role division method successfully achieved the picking of the can. The comparison example methods failed to find an inverse kinematics solution to picking the can from the final base position achieved after opening the door. In addition to not being able to achieve the full task sequence, the high-only comparison example method and no-role comparison example method had a motion jump where the robot hand departed from the door handle, which would break the door handle if executed in a real life environment. The low-only comparison example method had a collision with the door during motion execution. With the body role division method, there were no collisions in all tasks including the can picking, which is attributed to the mapping of the task demonstration of the task based on a number of degrees of freedom, as discussed above

The cause of the different results between high-only comparison example method, no-role comparison example methods, and body role division method, which all consider the task goals, can be explained as follows. First, by solving the orientational group independently, an inverse kinematics solver can find an acceptable orientation goal that is constrained under a desired configuration. However, when all goals are solved at one time, an inverse kinematics solver gets stuck to a local minimum that satisfies the exact orientation goal, but fails to maintain the desired configuration With the structure of the example robot, the result is an awkward, twisting configuration.

Second, by dividing joints contributing to motion and joints contributing to the task goal, a metric for deciding whether a configuration deviates from the demonstrated motion is determined. By ensuring that there is no deviation from the demonstrated motion and because motion continuity between likely transitions is guaranteed by the mapping scheme, jumping configurations are avoided. Moreover, the results show that a demonstrated dominant motion (i.e., arm motion) is able to indirectly guide an appropriate base positioning for a complex task sequence.

Further, based on the results, the first row of the table sums the number of waypoints that did not require base movement (i.e., failures in solving only with the joint configuration) when opening the door. Thus, the more effort in the mapping of the demonstrated motions, the less failures with solving with the joint configurations. The result of the comparison indicate that the low-level motion knowledge provides valuable information about how to execute a task in an efficient way.

The above-described method has also been evaluated using a fridge task experiment with a robot having less degrees of freedom than a human arm to provide a second use case scenario. The robot in the second use care scenario only has one arm. Thus, the fridge task experiment assumed tasks T1 and T2 followed by a task T3 “look for a can inside the fridge” task. The experimental conditions (including the demonstrated motions) were the same as the first use case scenario except the height of the fridge was adjusted to meet an operation-possible height of the robot of the second user case scenario, and due to robot's simple structure an analytic inverse kinematics solver was used in the below describe high-only comparison example method. The robot of the second use case scenario had no limitations for moving the base and joints at once, and thus, the body role division, as discussed above, was used without any robot-specific adjustments.

Since the robot of the second use care scenario has less degrees of freedom than a human arm and uses an analytic inverse kinematics solver, the solution provided by the high-only comparison example method may not be as awkward because mapping of the low-level demonstration is not as useful. However, a final base positioning is different between the high-only comparison example method and the body role division method. The body role division method allows the robot to look inside the fridge from a close and in-front position (and also the back of the door, where items could be stored in an actual fridge, whereas, the high-only comparison example results in a far and slightly-to-the-side position that cannot see the back of the door. Thus, the body role division method obtains an appropriate base positioning in a complex task sequence, even for a robot having less degrees of freedom than a human arm.

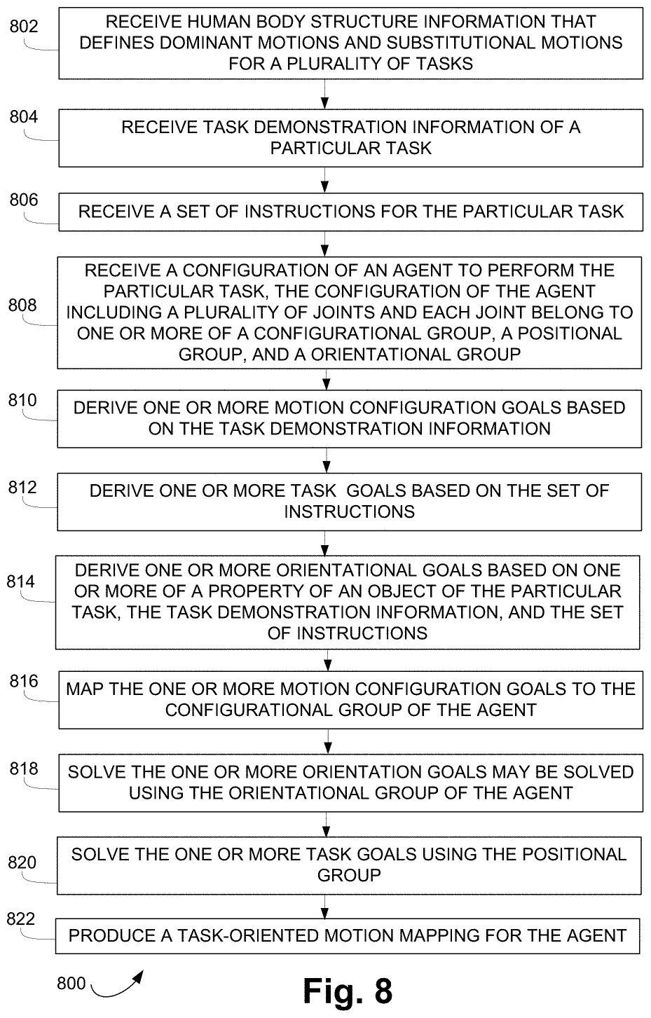

FIG. 8 depicts a method 800 for task-oriented motion mapping on an agent using body role division, according to embodiments of the present disclosure. Method 800 may begin at step 802, in which human body structure information that defines dominant motions and substitutional motions for a plurality of tasks may be received. The information about the structure of a human body may be used to determine which body parts are dominant. The human body structure information may then be used to produce a reasonable/appropriate mapping of a human body structure to machines, robots, agents, and/or virtual embodiments thereof. Other body parts, which are not dominant, may be substituted by other parts/configurations.

At step 804, the method may receive a configuration of an agent. The agent being able to perform the particular task and a plurality of tasks, the configuration of the agent including a plurality of joints. A human body may be decomposed into one or more body parts that are a dominant part of a motion, which provide guidance for simplifying motion planning, and one or more body parts that are substitutional. Similarly, an agent's joint configuration may be decomposed into a dominant group, which may be referred to as a configurational group, a substitutional group which may be referred to as a positional group, and an orientational group. In other words, at step 804, the method may receive a configuration of an agent, the configuration to perform a particular task of a plurality of tasks, and the configuration of the agent including a plurality of joints with each joint of the plurality of joints of the agent may belong to one or more of a configurational group, a positional group, and an orientational group. Accordingly, rather than mapping a whole human body to an agent's body configuration, the dominant parts of the motion, which provides guidance for simplifying motion planning, may only be mapped. Thus, dominant group may be obtained by mapping, and the remaining joints, substitutional group, may be solved by a task goal. To integrate a mobile base movement, base movements as part of a whole body configuration may be considered by defining a virtual prismatic and/or revolute joint attached to the agent's base. These virtual prismatic and/or revolute joints may belong to substitutional group but may also belong to dominant if the agent's configuration differs from a human structure. In order to map an agent based on an agent with different number of links, different patterns may be defined. In the exemplary embodiment discussed below, the dominant motion may be a human arm, and categorization of the three patterns may be based on similarity of arm structure when mapping an arm. A different categorization may be defined when a different body part is the dominant motion.

The first pattern may be a case where there are an number of equal degrees of freedom (DoF). For example, where there may be exactly two links, which excludes the hand, for representing the arm, which is the same as the human demonstrator. The second pattern may be a case where there are less DoF. For example, where there may be only one link for representing the arm, which is less than the human demonstrator. The third pattern may be a case where there are more DoF. For example, where there may be greater than two links for representing the arm, which is more than the human demonstrator.

At step 806, the method may receive task demonstration information of a particular task. The particular task is a task of the plurality of tasks or the particular task may not be one of the plurality of task. The task demonstration information of the particular task motion demonstration may be performed/captured and a digitalized representation of the motion, such as including, but not limited to, grasping, reaching, throwing, etc. Alternatively, or in addition, the task demonstration information may be a low-level demonstration, a sequence of human body postures may be provided during teaching. Then, each posture of the sequence of postures may be mapped to a defined joint configuration of an agent, such as a machine, robot, and/or virtual embodiments thereof. The low-level demonstration may provide configurational hints, which may simplify motion planning. A number of postures to map may be finite by using a form of digitalization. That is, from an obtained three-dimensional (3D) skeleton of a human body, a direction of each bone may be calculated, and then, a direction space into a number of segments may be divided. Next, dominate motions of the particular task may be defined based on the direction space digitization.

At step 808, the method may receive a set of instructions for the particular task. The set of instructions, such as verbal instructions, may be provided during teaching of an agent, such as a machine, robot, and/or virtual embodiment thereof, and then, the instructions may be decomposed into a set of task constraints derived from end-effector actions. The decomposition process may be done using the human body structure information which may include a knowledge database (e.g., using some lookup table, where a verb “open” with a target attribute “door” may be tied to a task model defining required parameters for generating a list of position goals on a circular trajectory).

Then, at step 810, one or more motion configuration goals may be derived from the task demonstration information of the particular task. Additionally, an orientational goal may optionally be derived at step 810. For example, a bone direction may be divided into eight horizontal directions (i.e., forward, left forward, left, left backward, backward, backward right, right, forward right) and five vertical directions (south pole, low, middle, high, north pole). The eight-by-five direction space digitalization may be a represented on each arm link to express a motion in a digitalized form. By defining a finite number of mapped configurations a priori, digitalized data may be able to filter noisy jumps in a human motion or obvious detection errors. For example, an unnatural arm twisted postures may be checked a priori in a digitalized form and then defined as unacceptable, whereas, raw continuous motion may produce increased noise from error in human bone tracking.

Then, at step 812, one or more task goals may be derived from the set of instructions for the particular task. Additionally, an orientational goal may optionally be derived at step 812. The set of instructions may be provided during teaching of an agent, such as a machine, robot, and/or virtual embodiment thereof. Then, a set of task constraints may be derived/decomposed from the set of instructions. For example, a task instruction may include a verbal instruction (e.g., “open a door”) or a demonstration (e.g., visual demonstration of the amount to open the door). Then, using a knowledge database, the task instruction may be converted into a set of task-specific parameters (e.g., target object shape, door opening amount). Finally, the task-specific parameters with a task-specific implementation, are used to generate a list of position goals or orientation goals.

Then, at step 814, one or more orientational goals may be derived from one or more of a property of an object of the particular task, the task demonstration information of the particular task, and the set of instructions. As explained above, the orientation of the end-effector may be important to note when performing end-effector actions (i.e., orientation goal). The orientation goal may be defined from properties (e.g., a shape) of an object to be manipulated, and may be obtained from the human demonstration to consider an entire task sequence. Alternatively, the orientation goals may be obtained from a database.

At step 816, the one or more motion configuration goals may be mapped to the configurational group of the agent. Then, at step 818, the one or more orientation goals may be solved using the orientational group of the agent. For example, joint position values in the orientational group may be changed to modify an initial configuration to a subsequent joint configuration which satisfy the orientational goal. Next, at step 820, the one or more task goals may be solved using the positional group of the agent. When solving the one or more task goal, joint values in the positional group may be changed. Additionally, when solving the one or more task goal the configurational group may be maintained using one or more of a configurational constraint and a group connection constraint. The changing of the joint position values in the orientational group and the changing of the joint values in the positional group may be performed by applying a fitness function in a genetic algorithm. Accordingly, using this decomposition of an agent body into three role groups, a joint configuration may be found that satisfies various above-identified goals and constraints. Thus at step 822, a task-oriented motion mapping for the agent may be produced based on the mapped configuration group, changed values in the orientation group, and changed values in the positional group.

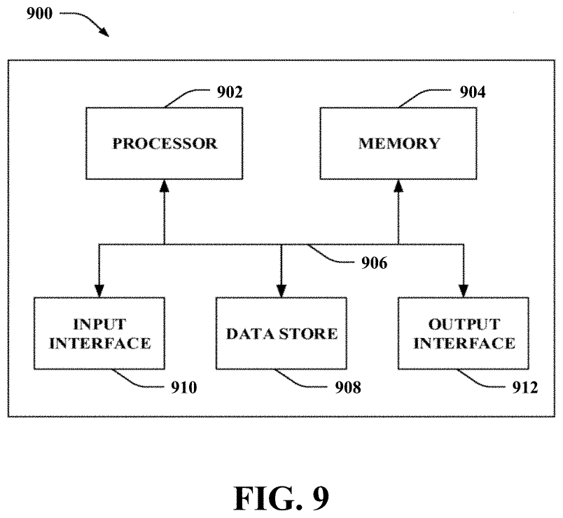

FIG. 9 depicts a high-level illustration of an exemplary computing device 900 that may be used in accordance with the systems, methods, and computer-readable media disclosed herein, according to embodiments of the present disclosure. For example, the computing device 900 may be used in a system for task-oriented motion mapping on an agent using body role division, according to embodiments of the present disclosure. The computing device 900 may include at least one processor 902 that executes instructions that are stored in a memory 904. The instructions may be, for example, instructions for implementing functionality described as being carried out by one or more components discussed above or instructions for implementing one or more of the methods described above. The processor 902 may access the memory 904 by way of a system bus 906. In addition to storing executable instructions, the memory 904 may also data, mappings, motion captures, instructions, and so forth.

The computing device 900 may additionally include a data store 908 that is accessible by the processor 902 by way of the system bus 906. The data store 908 may include executable instructions, tables, etc. The computing device 900 may also include an input interface 910 that allows external devices to communicate with the computing device 900. For instance, the input interface 910 may be used to receive instructions from an external computer device, from a user, etc. The computing device 900 also may include an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 may be included in an environment that provides substantially any type of user interface with which a user can interact. Examples of user interface types include graphical user interfaces, natural user interfaces, and so forth. For example, a graphical user interface may accept input from a user employing input device(s) such as a keyboard, mouse, remote control, or the like and may provide output on an output device such as a display. Further, a natural user interface may enable a user to interact with the computing device 900 in a manner free from constraints imposed by input device such as keyboards, mice, remote controls, and the like. Rather, a natural user interface may rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for example, several devices may be in communication by way of a network connection and may collectively perform tasks described as being performed by the computing device 900.

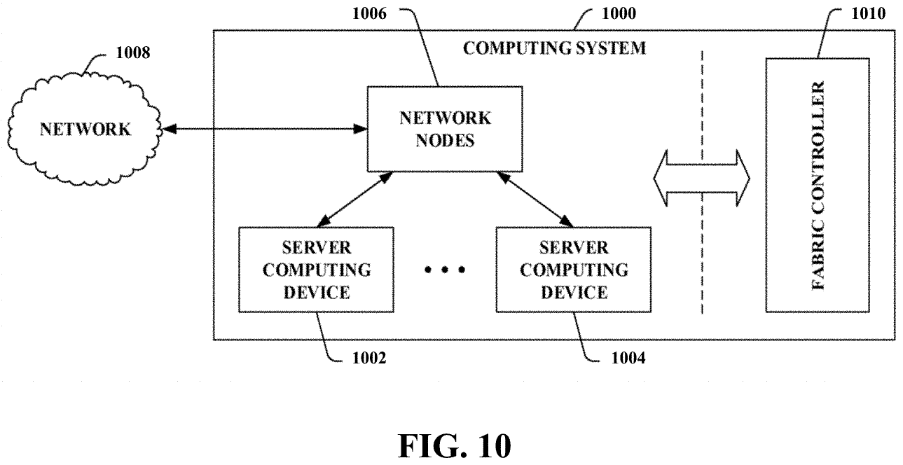

Turning to FIG. 10, FIG. 10 depicts a high-level illustration of an exemplary computing system 1000 that may be used in accordance with the systems, methods, and computer-readable media disclosed herein, according to embodiments of the present disclosure. For example, the computing system 1000 may be or may include one or more computing devices 900.

The computing system 1000 may include a plurality of server computing devices, such as a server computing device 1002 and a server computing device 1004 (collectively referred to as server computing devices 1002-1004). The server computing device 1002 may include at least one processor and a memory; the at least one processor executes instructions that are stored in the memory. The instructions may be, for example, instructions for implementing functionality described as being carried out by one or more components discussed above or instructions for implementing one or more of the methods described above. Similar to the server computing device 1002, at least a subset of the server computing devices 1002-1004 other than the server computing device 1002 each may respectively include at least one processor and a memory. Moreover, at least a subset of the server computing devices 1002-1004 may include respective data stores.

Processor(s) of one or more of the server computing devices 1002-1004 may be or may include the processor 902. Further, a memory (or memories) of one or more of the server computing devices 1002-1004 can be or include the memory 904. Moreover, a data store (or data stores) of one or more of the server computing devices 1002-1004 may be or may include the data store 908.

The computing system 1000 may further include various network nodes 1006 that transport data between the server computing devices 1002-1004. Moreover, the network nodes 1006 may transport data from the server computing devices 1002-1004 to external nodes (e.g., external to the computing system 1000) by way of a network 1008. The network nodes 1002 may also transport data to the server computing devices 1002-1004 from the external nodes by way of the network 1008. The network 1008, for example, may be the Internet, a cellular network, or the like. The network nodes 1006 may include switches, routers, load balancers, and so forth.

A fabric controller 1010 of the computing system 1000 may manage hardware resources of the server computing devices 1002-1004 (e.g., processors, memories, data stores, etc. of the server computing devices 1002-1004). The fabric controller 1010 may further manage the network nodes 1006. Moreover, the fabric controller 1010 may manage creation, provisioning, de-provisioning, and supervising of managed runtime environments instantiated upon the server computing devices 1002-1004.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein may be implemented in hardware, software, or any combination thereof. If implemented in software, the functions may be stored on and/or transmitted over as one or more instructions or code on a computer-readable medium. Computer-readable media may include computer-readable storage media. A computer-readable storage media may be any available storage media that may be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, may include compact disc (“CD”), laser disc, optical disc, digital versatile disc (“DVD”), floppy disk, and Blu-ray disc (“BD”), where disks usually reproduce data magnetically and discs usually reproduce data optically with lasers. Further, a propagated signal is not included within the scope of computer-readable storage media. Computer-readable media may also include communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio and microwave are included in the definition of communication medium. Combinations of the above may also be included within the scope of computer-readable media.

Alternatively, and/or additionally, the functionality described herein may be performed, at least in part, by one or more hardware logic components. For example, and without limitation, illustrative types of hardware logic components that may be used include Field-Programmable Gate Arrays (“FPGAs”). Application-Specific Integrated Circuits (“ASICs”), Application-Specific Standard Products (“ASSPs”), System-on-Chips (“SOCs”), Complex Programmable Logic Devices (“CPLDs”), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A computer-implemented method for task-oriented motion mapping on an agent using body role division, the method comprising:
receiving, at a computing system, task demonstration information of a particular task;
receiving, at the computing system, a set of instructions for the particular task;
receiving, at the computing system, a configuration of an agent to perform the particular task, the configuration of the agent including a plurality of joints, and each joint belong to one or more of a configurational group, a positional group, and a orientational group;
mapping, by the computing system, the configurational group of the agent based on the task demonstration information;
changing, by the computing system, values in the orientational group based on one or more of the task demonstration information and the set of instructions;
changing, by the computing system, values in the positional group based on the set of instructions; and
producing, by the computing system, a task-oriented motion mapping for the agent based on the mapped configuration group, changed values in the orientation group, and changed values in the positional group.

2. The method according to claim 1, further comprising:
receiving human body structure information that defines dominant motions and substitutional motions for a plurality of tasks,
wherein the particular task is a task of the plurality of tasks.

3. The method according to claim 3, wherein each joint of the plurality of joints are decomposed into the configurational group, the positional group, and the orientational group based on the received human body structure information that defines dominant motions and substitutional motions for the plurality of tasks.

4. The method according to claim 1, further comprising:
decoding the task demonstration information of the particular task into a sequence of postures;
calculating, for each posture of the sequence of postures, a direction of each bone of the task demonstration information;
dividing, for each bone direction, into a direction space digitization; and
extracting dominate motions of the particular task based on the direction space digitization.

5. The method of claim 1, further comprising:
deriving, by the computing system, one or more motion configuration goals based on the task demonstration information;
deriving, by the computing system, one or more task goals based on the set of instructions; and
deriving, by the computing system, one or more orientational goals based on one or more of a property of an object of the particular task, the task demonstration information, and the set of instructions,
wherein mapping the configurational group of the agent includes mapping the one or more task goals to the joint configuration based on the task demonstration information;
wherein changing values in the orientational group includes solving the one or more orientation goals using the orientation group; and
wherein changing values in the positional group includes solving the one or more positional goals using the positional group.

6. The method of claim 5, wherein solving the one or more positional goals using the positional group further includes maintaining changes of values in the configurational group.

7. The method of claim 6, wherein maintaining changes of values in the configurational group is based on a configuration constraint and a group connection constraints.

8. The method of claim 5, wherein the solving of the one or more orientation goals and one or more positional goals are performed by applying a fitness function in a genetic algorithm.

9. The method of claim 1, wherein mapping the configurational group of the agent based on the task demonstration information is further based on a number of links of the agent compared to a number of links of a demonstrator of the task demonstration information of the particular task.

10. A computing system for task-oriented motion mapping on an agent using body role division, the system comprising:
at least one processor; and
memory including instructions for task-oriented motion mapping on an agent using body role division, wherein the instructions, when executed by the at least one processor, include:
receiving task demonstration information of a particular task;
receiving a set of instructions for the particular task;
receiving a configuration of an agent to perform the particular task, the configuration of the agent including a plurality of joints, and each joint belong to one or more of a configurational group, a positional group, and a orientational group;
mapping the configurational group of the agent based on the task demonstration information;
changing values in the orientational group based on one or more of the task demonstration information and the set of instructions;
changing values in the positional group based on the set of instructions; and
producing a task-oriented motion mapping for the agent based on the mapped configuration group, changed values in the orientation group, and changed values in the positional group.

11. The system according to claim 10, wherein the instructions, when executed by the at least one processor, further include:
receiving human body structure information that defines dominant motions and substitutional motions for a plurality of tasks,
wherein the particular task is a task of the plurality of tasks.

12. The system according to claim 11, wherein each joint of the plurality of joints are decomposed into the configurational group, the positional group, and the orientational group based on the received human body structure information that defines dominant motions and substitutional motions for the plurality of tasks.

13. The system according to claim 10, wherein the instructions, when executed by the at least one processor, further include:
decoding the task demonstration information of the particular task into a sequence of postures;
calculating, for each posture of the sequence of postures, a direction of each bone of the task demonstration information;
dividing, for each bone direction, into a direction space digitization; and
extracting dominate motions of the particular task based on the direction space digitization.

14. The system according to claim 10, wherein the instructions, when executed by the at least one processor, further include:
deriving one or more motion configuration goals based on the task demonstration information;
deriving one or more task goals based on the set of instructions; and
deriving one or more orientational goals based on one or more of a property of an object of the particular task, the task demonstration information, and the set of instructions,
wherein mapping the configurational group of the agent includes mapping the one or more task goals to the joint configuration based on the task demonstration information;
wherein changing values in the orientational group includes solving the one or more orientation goals using the orientation group; and
wherein changing values in the positional group includes solving the one or more positional goals using the positional group.

15. The system according to claim 14, wherein solving the one or more positional goals using the positional group further includes maintaining changes of values in the configurational group.

16. The system according to claim 15, wherein maintaining changes of values in the configurational group is based on a configuration constraint and a group connection constraints.

17. The system according to claim 14, wherein the solving of the one or more orientation goals and one or more positional goals are performed by applying a fitness function in a genetic algorithm.

18. The system according to claim 10, wherein mapping the configurational group of the agent based on the task demonstration information is further based on a number of links of the agent compared to a number of links of a demonstrator of the task demonstration information of the particular task.

19. A computer-readable storage medium storing instructions that, when executed by a computing system, cause the computing system to perform a method for task-oriented motion mapping on an agent using body role division, the method including:
receiving task demonstration information of a particular task;
receiving a set of instructions for the particular task;
receiving a configuration of an agent to perform the particular task, the configuration of the agent including a plurality of joints, and each joint belong to one or more of a configurational group, a positional group, and a orientational group;
mapping the configurational group of the agent based on the task demonstration information;
changing values in the orientational group based on one or more of the task demonstration information and the set of instructions;
changing values in the positional group based on the set of instructions; and
producing a task-oriented motion mapping for the agent based on the mapped configuration group, changed values in the orientation group, and changed values in the positional group.

20. The computer-readable storage medium of claim 19, wherein the method further comprising:
deriving one or more motion configuration goals based on the task demonstration information;
deriving one or more task goals based on the set of instructions; and
deriving one or more orientational goals based on one or more of a property of an object of the particular task, the task demonstration information, and the set of instructions,
wherein mapping the configurational group of the agent includes mapping the one or more task goals to the joint configuration based on the task demonstration information;
wherein changing values in the orientational group includes solving the one or more orientation goals using the orientation group; and
wherein changing values in the positional group includes solving the one or more positional goals using the positional group.
